(19) United States
(12) Patent Application Publication
(10) Pub. No.: US 2005/0019465 A1
(43) Pub. Date: Jan. 27, 2005

(54) Quality improved cooked rice

(75) Inventors: Tatuya Yamamoto, Oura-gun (JP); Fumihiko Sano, Oura-gun (JP); Kouju Matsuo, Oura-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 10/879,036

(22) Filed: Jun. 30, 2004

(30) Foreign Application Priority Data
Jun. 30, 2003 (JP) 2003-187348
Mar. 16, 2004 (JP) 2004-074131

(51) Int. Cl. A23L 1/00

(52) U.S. Cl. 426/508

(57) ABSTRACT

Cooked rice having an improved quality and reduced amounts of broken cooked rice and/or crumbled cooked rice and suppressed unpleasant odors such as rice bran odor and old rice odor may be prepared by subjected rice to a steaming treatment at a temperature of from 100 to 250° C. for a period of from 0.1 to 60 seconds and, then, boiling the steamed rice.

### CROSS REFERENCES TO RELATED APPLICATIONS

This application claims priority to Japanese Patent Application Nos. 187348/2003, filed on Jun. 30, 2003, and 074131/2004, filed on Mar. 16, 2004, both of which are incorporated herein by reference in their entireties.

### BACKGROUND OF THE INVENTION

1. Field of the Invention

The present invention relates to cooked rice which has an improved quality. The present invention also relates to a method for preparing cooked rice which decreases the generation of broken cooked rice or crumbled cooked rice and suppresses unpleasant odors such as rice bran odor and old rice odor. The present invention further relates to processed cooked rice such as, particularly, retort foods and frozen foods.

2. Discussion of the Background

Cooked rice has conventionally been produced by various types of methods. For example, raw rice may be washed and, after being soaked in water, placed in a rice cooker and, after the addition of water, subjected to a final boiling treatment (referred to as “cooker rice cooking”). In another method, raw rice is washed and, after being soaked in water, subjected to a first steaming treatment and, then, after being soaked in hot water, subjected to a second steaming treatment (referred to as “steam rice cooking”; see, JP-A No. 59-224661). In still another method, raw rice is washed and, after being soaked in water, subjected to a first steaming treatment and, then, subjected to a final boiling treatment by being heated together with warm water or water in a rice cooker (see, JP-A No. 3-195465).

To provide a wash-free rice processing method which is free from the generation of cracks on the rice during the washing of the rice, a method is proposed in which a surface portion of milled rice is changed into the α-type by washing it with warm water having a temperature of 70° C. or more for a short period of time and, then, the rice thus-changed into the α-type is drained and, thereafter, dried (see, JP-A No. 3-65150).

According to the invention as described in JP-A No. 3-65150, however, after the milled rice is washed for a short period of time, draining and drying steps are necessary. Further, it is described therein that, when the temperature of the warm water is 80° C., a period of 2 minutes is preferable, while, when the temperature of the warm water is 100° C., a period of less than 15 seconds is preferable. Under these circumstances, since warm water remains around the rice for some time after it is washed, a gelatinized surface portion thereof becomes thick. For this reason, even when the rice is washed, the gelatinized portion is likely to remain and, accordingly, infiltration of water inside the rice is inhibited by the gelatinized layer, thereby sometimes resulting in cooked rice having a hard core. Further, as the temperature of the warm water becomes higher, the processing time becomes shorter, thereby enhancing productivity on an industrial scale. However, when warm water and raw rice having a temperature lower than that of the warm water are mixed and, then, treated, according to the invention as described in JP-A No. 3-65150, even when warm water having a temperature of, for example, 100° C. is used, such treatment is actually performed at a temperature which is lower than 100° C. by from a few to several tens of degrees, depending on the temperature and the amount of raw rice to be treated. Accordingly, not only is the enhancement of the productivity limited, but also it is difficult to reproduce a consistent treatment temperature condition unless the temperature of rice is adjusted.

There is also method for cooking rice which is characterized in that, for the purpose of removing an old rice odor, the rice is soaked in water and, then, the thus-soaked rice is steamed to change the starch thereof into a type in a first place and, thereafter, the resultant rice is subjected to a final boiling treatment by being heated together with warm water or water in a rice cooker (see, JP-A No. 3-195465).

In this method, a soaking step, a steaming step, and a boiling rice step are performed as a first step, a second step, and a third step, respectively. When the soaked rice is steamed, rice bran odor is removed according to the theory of steam distillation. However, according to the invention as described in JP-A No. 3-195465, in which the steaming step is performed after the soaking step, although the rice bran odor is removed to some extent according to the theory of steam distillation, it is difficult to remove the component of the old rice odor which has infiltrated into the rice through cracks generated thereon at the time of washing or soaking. Further, in the method according to the invention as described in JP-A No. 3-195465, there is a possibility of removing not only the rice bran odor but also the flavor intrinsic to rice.

There is a method for producing freeze-dried rice in which (1) washed rice is subjected to a boiling treatment (or steaming treatment) and, then, (2) such boiled rice (or steamed rice) is subjected to a steaming treatment (or boiling treatment) and, thereafter, (3) the resultant rice which underwent a double-step treatment of from the boiling step to the steaming step (or from the steaming step to the boiling step) is, (4) after the binding among the rice grains is released by water, (5) drained and, then, (6) freeze-dried under vacuum (see, JP-A No. 60-41452).

An object of the invention as described in JP-A No. 60-41452 is to remove any old rice odor by performing a steaming treatment. Further, another object thereof is to allow the rice grains to be porous to thereby allow the freeze-drying operation to be favorably performed in a short period of time. However, according to the invention as described in JP-A No. 60-41452, the steaming step is performed after a first washing step. Therefore, once the rice bran odor infiltrates inside the rice through cracks generated thereon in the washing step, it is difficult to remove the rice bran odor. For this reason, in Example 2 of JP-A No. 60-41452, the steaming period of time is set to be several tens of minutes, such as about 30 minutes, to thereby eliminate the old rice odor. Thus, in this method, there is also the possibility of removing not only the rice bran odor but also the flavor intrinsic to rice.

There is another method for producing cooked rice which is characterized in that, when cooked rice is produced by steaming raw rice and, then, boiling the thus-steamed rice, the water content of the raw rice is allowed to be less than 30% by weight (see, JP-A No. 2001-333707).

The term “raw rice” as used in JP-A No. 2001-333707 indicates rice (raw material rice) which is washed with a sufficient amount of water or warm water to be in a state in which rice bran and contaminants are removed therefrom and also in a state in which it is not yet steamed or boiled. Further, it is appropriate that the steaming period of time is approximately from 10 to 30 minutes. Still further, an object of the invention as described in JP-A No. 2001-333707 is to provide a method for producing Western style or Chinese style cooked rice in which the rice grains have weak adhesive force and, accordingly, are separated from one another, and each of the rice grains has appropriate stickiness and a soft texture.

Thus, there remains a need for a method of preparing cooked rice which is free from the above-mentioned drawbacks. There also remains a need for the cooked rice prepared by such a process.

### SUMMARY OF THE INVENTION

Accordingly, it is one object of the present invention to provide novel methods for preparing cooked rice.

It is another object of the present invention to provide novel methods for preparing cooked rice which exhibit a reduced tendency to generate broken cooked rice and/or crumbled cooked rice.

It is another object of the present invention to provide novel methods for preparing cooked rice which exhibit a reduced tendency to generate unpleasant odors, such as rice bran odor or old rice odor.

It is another object of the present invention to provide novel methods for preparing cooked rice which are suitable for the production of processed cooked rice, such as retort foods and/or frozen foods.

It is another object of the present invention to provide the cooked rice prepared by such a method.

It is another object of the present invention to provide processed foods which contain such cooked rice, such as retort foods and frozen foods.

Thus, it is an object of the present invention to provide cooked rice having an improved quality, which is prepared by a process capable of solving the problems of the generation of broken cooked rice or crumbled cooked rice and the generation of unpleasant odors such as rice bran odor and old rice odor, and which is appropriate for processed cooked rice such as, particularly, retort foods and frozen foods.

The present inventors have conducted intensive studies to solve the aforementioned problems and, as a result, have found that cooked rice having an improved quality with decreased generation of broken cooked rice or crumbled cooked rice and suppressed unpleasant odors such as rice bran odor and old rice odor can be provided by performing a steaming treatment on raw rice at a high temperature for a short period of time and, then, cooling the rice subjected to such treatment and, thereafter, boiling the thus-cooled rice. Accordingly, the present invention includes following embodiments:

(1) Cooked rice, which is prepared by a process, said process comprising:

(a) subjecting raw rice to a steaming treatment at a temperature of from 100 to 250° C. for a period of from 0.1 to 60 seconds, to obtain steamed rice;

(b) cooling said steamed rice, to obtain cooled rice; and

(c) boiling said cooled rice.

(2) Retort cooked rice, which is prepared by a process, said process comprising:

(a) subjecting raw rice to a steaming treatment at a temperature of from 100 to 250° C. for a period of from 0.1 to 60 seconds, to obtain steamed rice;

(b) cooling said steamed rice, to obtain cooled rice; and

(c) subjecting said cooled rice to a retort treatment.

(3) Frozen cooked rice, which is prepared by a process, said process comprising:

(a) subjecting raw rice to a steaming treatment at a temperature of from 100 to 250° C. for a period of from 0.1 to 60 seconds, to obtain steamed rice;

(b) cooling said steamed rice, to obtain cooled rice;

(c) boiling said cooled rice, to obtain boiled rice; and

(d) freezing said boiled rice.

(4) Processed rice, which is prepared by a process, said process comprising:

(a) subjecting raw rice to a steaming treatment at a temperature of from 100 to 250° C. for a period of from 0.1 to 60 seconds, to obtain steamed rice; and

(b) cooling said steamed rice.

(5) A process for preparing cooked rice, said process comprising:

(a) subjecting raw rice to a steaming treatment at a temperature of from 100 to 250° C. for a period of from 0.1 to 60 seconds, to obtain steamed rice;

(b) cooling said steamed rice, to obtain cooled rice; and

(c) boiling said cooled rice.

(6) A process for preparing retort cooked rice, said process comprising:

(a) subjecting raw rice to a steaming treatment at a temperature of from 100 to 250° C. for a period of from 0.1 to 60 seconds, to obtain steamed rice;

(b) cooling said steamed rice, to obtain cooled rice; and

(c) subjecting said cooled rice to a retort treatment.

(7) A process for preparing frozen cooked rice, said process comprising:

(a) subjecting raw rice to a steaming treatment at a temperature of from 100 to 250° C. for a period of from 0.1 to 60 seconds, to obtain steamed rice;

(b) cooling said steamed rice, to obtain cooled rice;

(c) boiling said cooled rice, to obtain boiled rice; and

(d) freezing said boiled rice.

(8) A process for preparing processed rice, said process comprising:

(a) subjecting raw rice to a steaming treatment at a temperature of from 100 to 250° C. for a period of from 0.1 to 60 seconds, to obtain steamed rice; and

(b) cooling said steamed rice.

Further, it has been found that, when the rice is old, the effectiveness is particularly enhanced.

As an advantage according to the present invention, it is possible to provide cooked rice having an improved quality with decreased generation of broken cooked rice or crumbled cooked rice and suppressed unpleasant odors such as rice bran odor and old rice odor.

### DETAILED DESCRIPTION OF THE PREFERRED EMBODIMENTS

Thus, in one embodiment, the present invention provides a process for preparing cooked rice, which comprises:

(a) subjecting raw rice to a steaming treatment at a temperature of from 100 to 250° C. for a period of from 0.1 to 60 seconds, to obtain steamed rice;

(b) cooling said steamed rice, to obtain cooled rice; and

(c) boiling said cooled rice.

According to the present invention, when the steaming treatment is performed on the raw rice, it is important to perform the treatment at a temperature of from 100 to 250° C. for a period of from 0.1 to 60 seconds. The steaming treatment temperature is preferably from 105 to 180° C. and, more preferably, from 110 to 150° C. It is to be understood that these temperatures refer to the temperature of the steam. The steaming treatment period of time is preferably from 0.5 to 15 seconds and, more preferably, from 1 to 5 seconds. When the treatment temperature is 250° C. or more, burning and sticking of the surface of rice tend to occur, and accordingly such a case is not preferable. When the temperature is 100° C. or less, the rice is directly treated by warm water instead of steam, thereby allowing a gelatinized layer of the surface of the rice to become thick and also such thickness of the gelatinized layer to be difficult to be controlled, and thus, such a case is not preferable, either.

When the cooked rice is produced by using Japonica rice, it is desirable that the treatment period of time be within 15 seconds. When the treatment period of time is 15 seconds or more, the gelatinized layer of the surface of the rice becomes unduly thick, and the case is not preferable. When the treatment period of time is 0.1 second or less, a sufficient effect can hardly be obtained, and the case is not preferable, either. However, when Indica rice is used, or depending on applications of the cooked rice, it is sometimes rather desirable that the steam treatment period of time is 15 seconds or more. However, even in this case, when the steam treatment period of time is over one minute, starch on a surface of rice is excessively peeled off. Such peeling-off causes roughening of the surface of the rice or deterioration of yield, which is not preferable.

Raw rice is subjected to a steaming treatment and, then, such steamed rice is cooled. The cooling of the rice is important to stabilize quality. Although in the present invention, the cooling condition of the rice is not specifically limited, a condition which cools the rice to a gelatinization temperature thereof (about 60° C.) or less is particularly important. When the cooling speed is low, a portion of the heat is transmitted inside the rice and, accordingly, the thickness of a gelatinized layer becomes thick, while, to the contrary, when the cooling speed is high, the thickness of the gelatinized layer becomes thin. Therefore, when the cooling condition differs in each case, the thickness of the gelatinized layer differs from one case to another case and, accordingly, the cooked rice comes to have a different texture every time; a feature which is not favorable. The cooling of the rice which has been subjected to the steaming treatment is ordinarily performed by allowing the rice to be in contact with water in a washing or soaking step after the steaming treatment is performed on the rice. Alternatively, the object of the cooling can be attained by just leaving the rice which has been subjected to the steaming treatment to stand at room temperature. In this case, when the rice which has been subjected to the steaming treatment is spread thin on, for example, a tray, the cooling speed is increased, which is favorable. Still further, it is permissible to actively blow cool air on the rice which has been subjected to the steaming treatment. Hereinafter, the steaming treatment of the raw rice is sometimes also referred to as a “high-temperature short-period pretreatment.”

According to the present invention, in the steaming treatment, any known method can be adopted, and it is particularly preferable to employ, for example, a steam circulating-type thawing apparatus or a powder sterilization apparatus. This is because these methods allow the steam and rice to be in contact directly and evenly with each other consuming a short period of time.

The rice to be used in the present invention is by no means limited to any specific type (cultivar), and any of non-glutinous rice, glutinous rice, low amylose rice, high amylose rice and the like can be used.

The term “raw rice” as used herein is intended to include not only raw rice before being subjected to a washing treatment, but also so-called wash-free rice produced by various types of methods such as a method in which a pre-washing treatment is performed on the raw rice by using a small amount of water for the purpose of removing rice bran, another method in which the rice bran is scraped out by attaching tapioca starch on a surface of the raw rice, and still another method in which the rice bran on the surface of the raw rice is scraped out by using, for example, a brush. When the wash-free rice is used in the present invention, a washing step which is to be performed after a steaming step becomes unnecessary, which causes a gelatinized layer to be left on the surface of the rice in a large amount compared with the rice which goes through the washing step. For this reason, cooked rice which undergoes a final boiling treatment comes to have a somewhat hard core. Therefore, for the applications to risotto and the like, the wash-free rice gives a favorable texture. Further, the wash-free rice which is subjected to the pre-washing treatment by using a small amount of water for the purpose of removing the rice bran is ordinarily subjected, after a washing step, to a draining step and, subsequently, a drying step. According to the present invention, however, when the wash-free rice is subjected to a high-temperature short-period pretreatment immediately after the wash-free rice is produced, the drying step is not always necessary.

According to the present invention, after the rice is subjected to the steaming treatment, the rice is boiled. The boiling conditions are not particularly limited.

According to the present invention, cooked rice which has been subjected to a final boiling treatment can also be frozen to thereby become frozen cooked rice. When the cooked rice obtained according to the invention is used, even when a treatment which allows grains of the cooked rice to be separated from one another is performed on the cooked rice at the time of freezing it, the amount of broken cooked rice is not increased. Therefore, this case is advantageous in this regard as described above. Further, in this case, since the broken or cracked cooked rice is small in quantity, moisture evaporation from the cooked rice at the time of thawing is small and, accordingly, the taste of the thawed cooked rice can be kept in a state of sharp soft texture.

The term “frozen cooked rice” as used herein means any type of cooked rice which can be produced at a temperature of −5° C. or less and put in a distribution channel, regardless of expression, such as “frozen” and “chilled”. However, when the temperature of the frozen cooked rice is −15° C. or less, the transition of moisture is effectively suppressed, and such case is advantageous. Since the cooked rice obtained according to the present invention is suitable for a frozen food, it can be preserved in the form of frozen food and, then, used. As for a freezing method in such case as described above, any method which is applied in producing an ordinary frozen food, for example, a method for loosening and freezing cereals in the form of separate grains as described in JP-A Nos. 50-105847 and 63-44857 can be utilized.

In another embodiment according to the present invention, rice which has been subjected to a high-temperature short-period pretreatment is contained in a heat resistant container together with water and, then, subjected to a sterilization treatment under pressure and, as a result, retort cooked rice can be produced. According to the present invention, even in the case in which rice is boiled with a large amount of water, the amount of broken cooked rice is hardly increased and, therefore, the case is favorable. Further, when soaked or washed rice is charged into a container on a metered-amount basis, though not limited to the soaked or washed rice, load is apt to be put on the soaked or washed rice to sometimes break the soaked or washed rice. However, when such charging is performed after the high-temperature short-period pretreatment is performed, the breakage of the cooked rice can be decreased.

According to the present invention, immediately after the rice is subjected to a steaming treatment, the treated rice is cooled and, then, the thus-cooled rice can be handled in the same manner as raw rice. The treated rice can be stored in a container for a long period of time. At the time of storage, it is preferable that the average moisture regain is 16% or less per rice grain.

Other features of the invention will become apparent in the course of the following descriptions of exemplary embodiments which are given for illustration of the invention and are not intended to be limiting thereof.

### EXAMPLES

In the following examples, and throughout this specification, all parts and percentages are by weight, and all temperatures are in degrees Celsius, unless expressly stated to be otherwise.

### Example 1

Cooked rice was prepared by a process using a rice cooker in which “KIRARA 397” rice of Heisei 8 (1996) harvest was used and a high-temperature short-period pretreatment was performed.

Rice used: harvest year: Heisei 8 (1996); harvest place: Hokkaido; cultivar: KIRARA 397;

Mixture: milled rice: 100 g; water: 130 g; and

Production method:

(1) raw rice was subjected to a high-temperature short-period pretreatment (steaming apparatus: available from Nippon Sanso Corporation; Flec Server; 2 seconds; about 110° C.);

(2) the treated rice was soaked in a volume of water 30 times that of the rice (V/V) at 20° C. for 15 seconds (corresponding to a cooling step);

(3) the thus-soaked rice was washed (temperature of water used for washing: 20° C.; temperature of rice: room temperature; number of washing: by hand washing, 20 times×3 times; washing period of time: 5 minutes);

(4) the thus-washed rice was soaked (soaking conditions: 20° C., 60 minutes); and, then,

(5) the thus-soaked rice was boiled (rice cooking apparatus: Matsushita Electric Industrial Co., Ltd.; SR-03 Type; capacity:0.27 L; boiling period of time: 15 minutes; steaming period of time: 15 minutes).

The thus-boiled rice was designated as Example 1 cooked rice.

### Comparative Example 1

Cooked rice was prepared by a process using a rice cooker in which “KIRARA 397” rice of Heisei 8 (1996) harvest was used but a high-temperature short-period pretreatment was not performed.

The rice was boiled in the same manner as in Example 1 except that the hot-temperature short-period pretreatment (1) in Example 1 was not performed. The thus-boiled rice was designated as Comparative Example 1 cooked rice.

### Example 2

Cooked rice was prepared by a cooking method in which “KIRARA 397” rice of Heisei 8 (1996) harvest was used, a high-temperature short-period pretreatment was performed and soaked rice was steamed and, then, boiled.

The cooked rice was prepared as in Example 1, with the exception that after the soaking step (4) in Example 1 was performed, a steaming step was performed (steaming apparatus: steamer for household use; steaming conditions: 100° C., 15 minutes) and, after the steaming step was performed, a boiling step is performed with a boiling period of time in step (5) of 8 minutes to boil the rice (rice cooking apparatus: Matsushita Electric Industrial Co., Ltd.; SR-03 Type; capacity:0.27 L; boiling period of time: 8 minutes; steaming period of time: 15 minutes).

The thus-boiled rice was designated as Example 2 cooked rice.

### Comparative Example 2

Cooked rice was prepared by a cooking method in which “KIRARA 397” rice of Heisei 8 (1996) harvest was used, a high-temperature short-period pretreatment was not performed and soaked rice was steamed and, then, boiled.

The rice was boiled in a same manner as in Example 2 except that the hot-temperature short-period pretreatment (1) in Example 2 was not performed. The thus-boiled rice was designated as Comparative Example 2 cooked rice.

### Reference Example 1

Cooked rice was prepared by using a rice cooker in which “KOSHIHIKARI” rice of Heisei 14 (2002) harvest was used, and a high-temperature short-period pretreatment was performed.

The rice was boiled in a same manner as in Example 1 except that the rice used was changed to: harvest year: Heisei 14 (2002); harvest place: Niigata; cultivar: KOSHIHICAR. The thus-boiled rice was designated as Reference Example 1 cooked rice.

### Reference Example 2

Cooked rice was prepared by using a rice cooker in which “KOSHIHIKARI” rice of Heisei 14 (2002) harvest was used, and a high-temperature short-period pretreatment was not performed.

The rice was boiled in a same manner as in Reference Example 1 except that the high-temperature short-period pretreatment (1) in Reference Example 1 was not performed. The thus-boiled rice was designated as Reference Example 2 cooked rice.

The products of Example 1, Example 2, Comparative Example 1, and Comparative Example 2 were evaluated, and the evaluation results are shown in Table 1.

TABLE 1

| | | Compara- | | |
|---|---|---|---|---|
| | | tive | | Comparative |
| | Example 1 | Example 1 | Example 2 | Example 2 |
| Crushed | 3.3 | 7.6 | 4.1 | 5.9 |
| cooked | | | | |
| rice | | | | |
| ratio (%) | | | | |
| Aroma | 5,000,000 | 6,500,000 | 2,200,000 | 3,400,000 |
| compo- | | | | |
| nent | | | | |
| Comment | Though small, | Extremely | Though small, | Though small, |
| | abnormal odor | unsavory, | abnormal odor | abnormal odor |
| | is present | abnormal | is present | is present |
| | | odor is | | |
| | | present | | |
| Evaluation | 3 | 2 | 4 | 3 |
| point | | | | |

The products of Reference Example 1 and Reference Example 2 were evaluated, and the evaluation results are shown in Table 2.

TABLE 2

| | Reference | Reference |
|---|---|---|
| | Example 1 | Example 2 |
| Crushed cooked rice ratio (%) | 2.8 | 3.0 |
| Aroma component | 330,000 | 460,000 |
| Comment | Favorable | Favorable |
| Evaluation point | 5 | 5 |

In Table 1 and Table 2, the crushed cooked rice ratio was calculated in accordance with the following formula:

Crushed cooked rice ratio (%)=100×{(the number of grains which have come to be ⅔ or less of ordinary size)÷2}÷{the number of grains of ordinary size+(the number of grains which have come to be ⅔ or less of ordinary size÷2)}.

In Table 1 and Table 2, the amount of the aroma component was determined by using GC/MS (apparatus used: Shimadzu Corporation GC-17A/JEOL Ltd. Automass SUN 200; column used: J&W Science DB-5, 60 mm-0.25 mm (inner diameter)-0.25 μm (layer thickness); extraction method: solid layer microextraction). As for the thus-determined amounts, the amounts of detected n-hexanal against the dry solid content of the rice are shown as relative values in terms of figures calculated from an area on a chart.

In Table 1 and Table 2, evaluation was performed by a 5-membered panel, and the criterion for the evaluation was set as 1 point: extremely unsavory; 2 points: unsavory; 3 points: ordinary; 4 points: savory; and 5 points: extremely savory.

From Table 1 and Table 2, it was found that the crushed cooked rice ratio was decreased by the hot-temperature short-period pretreatment and the amount of n-hexanal which is a representative component of a rice bran odor and an old rice odor was inclined to be decreased.

In Reference Example 1 and Reference Example 2, new rice was used. In each of Reference Examples 1 and 2, the crushed ratio and evaluation point were satisfactory. This shows that the present invention is effective when new rice was used and is particularly effective when the old rice or the like is used.

As the reason for such features as described above, it is assumed that, even when the surface of cooked rice is heated, since no sufficient amount of water is present around the rice, the rice after being subjected to a final treatment is in a state in which only a thin portion of a surface layer thereof is gelatinized by absorbing water and, accordingly, when the rice after being subjected to the final treatment is washed, such gelatinized surface layer is gradually peeled off and, as a result, water absorption into the inside of the rice is not inhibited to thereby produce cooked rice having no hard core.

In ordinary washing and soaking methods of raw rice, swelling of the rice by the absorption of water begins at an early stage of the washing treatment to cause a strain in the rice and, as a result, cracks are sometimes generated on the rice. It is considered that, according to the present invention, since an extremely thin surface layer of the rice absorbs water and is gelatinized, the surface layer becomes soft and resilient, and cracks are hardly generated on the surface layer. For this reason, it is thought that generation of cracks or breakage of the cooked rice at the time of the final boiling treatment is decreased and also the infiltration of a rice bran component into the cooked rice is suppressed.

### Example 3

Processed rice was prepared by performing a high-temperature short-period pretreatment on raw rice.

Rice used: harvest year: Heisei 9 (1997); harvest place: Hokkaido; cultivar: KIRARA 397.

The method for producing processed rice was as follows:

(1) raw rice was subjected to a high temperature pretreatment (steaming apparatus: Okawara Mfg., Co., Ltd.; Powder grain sterilization apparatus SIRV-20 TYPE; 3 seconds; about 130° C.); and

(2) the treated rice was cooled by being mixed with powdery dry ice (product temperature: about −60° C.) in an amount of about 2 times that of the treated rice immediately after the pretreatment was performed and, then, left to stand in a refrigerator for one day in order to evaporate the dry ice and, thereafter, allowed to return to room temperature (about 20° C.). The resultant rice was designated as Example 3 rice.

The raw rice (harvest year: Heisei 9 (1997); harvest place: Hokkaido; cultivar: KIRARA 397) which was used in Example 3 was designated as Comparative Example 3.

Example 3 rice and Comparative Example 3 rice were put in respective bags of the same type and stored at room temperature (about 20° C.) for 2 weeks and, then, the moisture regains thereof were measured by a drying method.

As a result, the moisture regain of Example 3 rice was 16%, while that of Comparative Example 3 rice was 15%; both moisture regains are almost same with each other.

Example 3 rice and Comparative Example 3 rice were subjected to the same conditions as in Example 1, namely, a washing step (3), a soaking step (4), and a boiling step (5) in the stated order and, then, the cooked rice of Example 3 rice and Comparative Example 3 rice which had been subjected to a final boiling treatment were compared.

The results are shown in Table 3. On this occasion, the crushed cooked rice ratio, aroma component, and evaluation point were calculated in a same manner as in Tables 1 and 2, and, then, the values obtained for Example 3 were divided by the corresponding evaluation values obtained for Comparative Example 3 to obtain values defined as the “fluctuation rate of crushed cooked rice ratio,” the “fluctuation rate of aroma component,” and the “fluctuation rate of evaluation point,” respectively, and these values are given in Table 3.

TABLE 3

| | Example 3/ |
|---|---|
| | Comparative Example 3 |
| Fluctuation rate of crushed cooked rice ratio | 0.65 |
| Fluctuation rate of aroma component | 0.73 |
| Fluctuation rate of evaluation point | 1.5 |

From Table 3, it was found that, even when a cooling process was performed by using dry ice instead of soaking in water after the high-temperature pretreatment was performed, the crushed cooked rice ratio and the aroma component (amount of n-hexanal) were decreased and, accordingly, the evaluation point was enhanced.

The appearance of the rice obtained in Example 3 was equivalent to that of the raw rice in Comparative Example 3. Furthermore, even after the rice obtained in Example 3 was stored at room temperature, no problem was generated in quality thereof. It was found that the rice can be stored and put on a distribution channel in the same manner as in ordinary raw rice.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A process for preparing cooked rice, said process comprising:
(a) steaming raw rice at a temperature of 100 to 250° C. for a time of 0.1 to 60 seconds, to obtain steamed rice;
(b) cooling said steamed rice, to obtain cooled rice; and
(c) boiling said cooled rice.

2. The process of claim 1, wherein said raw rice is steamed at a temperature of 105 to 180° C. for a time of 0.5 to 15 seconds.

3. The process of claim 1, wherein said raw rice is steamed at a temperature of 110 to 150° C. for a time of 1 to 5 seconds.

4. The process of claim 1, wherein said streamed rice is cooled to a temperature of 60° C. or less.

5. The process of claim 1, wherein said streamed rice is cooled to a temperature of 25° C. or less.

6. Cooked rice, which is prepared by a process according to claim 1.

7. A process for preparing retort cooked rice, said process comprising:
(a) steaming raw rice at a temperature of 100 to 250° C. for a time of 0.1 to 60 seconds, to obtain steamed rice;
(b) cooling said steamed rice, to obtain cooled rice; and
(c) subjecting said cooled rice to a retort treatment.

8. The process of claim 7, wherein said raw rice is steamed at a temperature of 105 to 180° C. for a time of 0.5 to 15 seconds.

9. The process of claim 7, wherein said raw rice is steamed at a temperature of 110 to 150° C. for a time of 1 to 5 seconds.

10. The process of claim 7, wherein said streamed rice is cooled to a temperature of 60° C. or less.

11. The process of claim 7, wherein said streamed rice is cooled to a temperature of 25° C. or less.

12. Retort cooked rice, which is prepared by a process according to claim 7.

13. A process for preparing frozen cooked rice, said process comprising:
(a) steaming raw rice at a temperature of 100 to 250° C. for a time of 0.1 to 60 seconds, to obtain steamed rice;
(b) cooling said steamed rice, to obtain cooled rice;
(c) boiling said cooled rice, to obtain boiled rice; and
(d) freezing said boiled rice.

14. The process of claim 13, wherein said raw rice is steamed at a temperature of 105 to 180° C. for a time of 0.5 to 15 seconds.

15. The process of claim 13, wherein said raw rice is steamed at a temperature of 110 to 150° C. for a time of 1 to 5 seconds.

16. The process of claim 13, wherein said streamed rice is cooled to a temperature of 60° C. or less.

17. The process of claim 13, wherein said streamed rice is cooled to a temperature of 25° C. or less.

18. Frozen cooked rice, which is prepared by a process according to claim 13.

19. A process for preparing processed rice, said process comprising:
(a) steaming raw rice at a temperature of 100 to 250° C. for a time of 0.1 to 60 seconds, to obtain steamed rice; and
(b) cooling said steamed rice.

20. The process of claim 19, wherein said raw rice is steamed at a temperature of 105 to 180° C. for a time of 0.5 to 15 seconds.

21. The process of claim 19, wherein said raw rice is steamed at a temperature of 110 to 150° C. for a time of 1 to 5 seconds.

22. The process of claim 19, wherein said streamed rice is cooled to a temperature of 60° C. or less.

23. The process of claim 19, wherein said streamed rice is cooled to a temperature of 25° C. or less.

24. Processed rice, which is prepared by a process according to claim 19.
